(19) United States
(12) Patent Application Publication
(10) Pub. No.: US 2023/0246446 A1
(43) Pub. Date: Aug. 3, 2023

(54) A GRID CONNECTED BATTERY STORAGE SYSTEM

(71) Applicant: VESTAS WIND SYSTEMS A/S, Aarhus N. (DK)

(72) Inventors: Karthikeya Balladi RAGHUCHANDRA, Aarhus N (DK); Michel Maher Naguib REZKALLA, Aarhus N (DK); Lars Christian CHRISTENSEN, Viborg (DK)

(21) Appl. No.: 17/922,530

(22) PCT Filed: Apr. 29, 2021
(86) PCT No.: PCT/DK2021/050133

§ 371 Date: Oct. 31, 2022

(30) Foreign Application Priority Data
Apr. 30, 2020 (DK) PA 2020 70275

(51) Int. Cl. H02J 3/32

(52) U.S. Cl. CPC H02J 3/32

(57) ABSTRACT

A grid connected battery storage system comprising two or more DC/AC power converter systems, two or more DC/DC power converters, and two or more DC electrical storage units is disclosed. Each DC/DC power converter has at least one DC electrical storage unit connected thereto, in such a manner that the voltage capability of the storage unit(s) matches the DC voltage level rating of the DC/DC power converter, thereby forming at least one DC block having a voltage capability defined by the voltage capability of the storage unit(s) of the DC block and a DC voltage level rating defined by the DC voltage level rating(s) of the DC/DC power converter(s) . Each DC block is connected to a DC/AC power converter system via a DC bus bar and at least one switch, in such a manner that the DC voltage level ratings of the DC/AC power converter systems match the voltage capability of the DC blocks.

### FIELD OF THE INVENTION

The present invention relates to a grid connected battery storage system, i.e. a system for storing electrical energy. The system is electrically connected to an AC power grid, thereby being able to receive electrical energy from the power grid and to provide electrical energy to the power grid. Accordingly, the battery storage system may act as a power buffer for the power grid.

### BACKGROUND OF THE INVENTION

AC power grids, such as large supply grids, need to balance power produced by power suppliers and provided to the power grid, and power consumed by consumers connected to the power grid. This is in order to ensure that there is a match between power production and power consumption, thereby ensuring that all consumers receive sufficient power, but also in order to ensure stability of the AC power grid with respect to frequency and voltage.

It is difficult to directly control power production and consumption in an AC power grid in such a manner that a perfect match is obtained at all times. Therefore AC power grids may be provided with power buffers, in the form of energy storage systems, such as battery storage systems, in which electrical energy can be stored during time periods of surplus power production, and the stored electrical energy can be supplied to the power grid during time periods of deficient power production. Such battery storage systems often comprise a number of batteries which can each be charged or discharged in accordance with the requirements of the power grid. Thus, when it is required to receive or supply power from/to the power grid, it needs to be determined which of the batteries to charge or discharge.

US 9,537,318 B2 discloses an energy storage system with modular energy storage, which may be connected to a power grid. The energy storage units may differ from each other with regard to an electrical characteristic, current capacity, voltage, or with regard to a physical characteristic. The modular storage system may include one or more power conversion units coupleable to an external system. A controller is configured to selectively cause one or more of the energy storage units to be connected to one or more of the power conversion units based, e.g., on an amount of energy stored in the one or more energy storage units.

### DESCRIPTION OF THE INVENTION

It is an object of embodiments of the invention to provide a grid connected battery system in which DC electrical storage units of different types can easily be connected to the system in an appropriate manner.

It is a further object of embodiments of the invention to provide a grid connected battery system in which a capacity of DC electrical storage units of the battery system can be utilised in an optimal manner.

The invention provides a grid connected battery storage system comprising:
two or more DC/AC power converter systems, each DC/AC power converter system being connected to an AC power grid and to a DC bus bar, and the DC/AC power converter systems being of at least two different DC voltage level ratings,
two or more DC/DC power converters, the DC/DC power converters being of at least two different DC voltage level ratings,
two or more DC electrical storage units, the DC electrical storage units being of at least two types, where different types of DC electrical storage units have different voltage capabilities relating to charging and/or discharging of the DC electrical storage unit,

wherein each DC/DC power converter has at least one DC electrical storage unit connected thereto, in such a manner that the voltage capability of the DC electrical storage unit(s) matches the DC voltage level rating of the DC/DC power converter, thereby forming at least one DC block, each DC block comprising at least one of the at least two DC electrical storage unit and at least one of the at least two DC/DC power converter, each DC block having a voltage capability defined by the voltage capability of the DC electrical storage unit(s) of the DC block and a DC voltage level rating defined by the DC voltage level rating(s) of the DC/DC power converter(s), and
wherein each DC block is connected to a DC/AC power converter system via the DC bus bar and at least one switch, in such a manner that the DC voltage level ratings of the DC/AC power converter systems match the voltage capability of the DC blocks.

Thus, the invention provides a grid connected battery storage system. In the present context the term ‘battery storage system’ should be interpreted to mean a system which is capable of storing electrical energy by means of a number of energy storing units, such as batteries, in the manner described above. In the present context the term ‘grid connected’ should be interpreted to means that the battery storage system is electrically connected to an AC power grid, and that the system is therefore capable of receiving and supplying power from and to the AC power grid.

The battery storage system comprises two or more DC/AC power converter systems, two or more DC/DC power converters and two or more DC electrical storage units. The DC/AC power converter systems as well as the DC/DC power converters are bidirectional. This is described in further detail below.

Each DC/AC power converter system is connected to an AC power grid and to a DC bus bar. Thus, each DC/AC power converter system thereby electrically interconnects the DC bus bar and the AC power grid. Furthermore, each DC/AC power converter system is able to convert AC power received from the AC power grid into DC power, when the battery storage system is receiving power from the AC power grid, and to convert stored DC power into AC power, when the battery storage system is supplying power to the AC power grid.

The DC/AC power converter systems differ from each other in the sense that they are of at least two different DC voltage level ratings. Accordingly, at least one of the DC/AC power converter systems is of a first DC voltage level rating, and at least one of the other DC/AC power converter systems is of a second DC voltage level rating, and the first DC voltage level rating differs from the second DC voltage level rating.

In the present context the term ‘DC voltage level rating’ should be interpreted to mean a maximum DC voltage which the DC/AC power converter system is able to handle when performing power conversion from AC power to DC power or from DC power to AC power. Thus, various DC voltage level ratings can be selected by selecting an appropriate one of the DC/AC power converter systems.

Each DC/DC power converter is able to convert DC from one DC voltage level to another DC voltage level, one DC voltage level being higher than the other DC voltage level. The voltage conversion may be in both directions, i.e. from the high DC voltage level to the low DC voltage level, or from the low DC voltage level to the high DC voltage level, depending on whether power is supplied to or from the power grid.

Similarly to the DC/AC power converter systems, the DC/DC power converters are also of at least two different DC voltage level ratings. The DC voltage level ratings may refer to the low DC voltage level as well as to the high DC voltage level.

The DC electrical storage units are of at least two different types. Accordingly, at least one of the DC electrical storage units is of a first type while at least one of the other DC electrical storage units is of a second type, and the first type differs from the second type.

In the present context the term ‘different types of DC electrical storage units’ should be interpreted to mean that the DC electrical storage units differ from each other in terms of voltage capability relating to charging and/or discharging of the DC electrical storage unit. Thus, a DC electrical storage unit of a first type has a first voltage capability when charging and/or discharging, and a DC electrical storage unit of a second type has a second voltage capability when charging and/or discharging, and the first voltage capability differs from the second voltage capability.

In the present context the term ‘voltage capability relating to charging and/or discharging’ should be interpreted to mean the capability of the DC electrical storage unit to handle voltage when charging or discharging.

According to one embodiment, the voltage capability is a voltage range. In the present context the term ‘voltage range’ should be interpreted to mean a DC voltage range between a minimum threshold voltage and a maximum allowed voltage of the DC electrical storage unit, while the DC electrical storage unit is charging or discharging.

Thus, the voltage capability may, e.g., relate to an optimal state-of-charge range of the DC electrical storage unit. For instance, the DC electrical storage units may each have a state-of-charge range in which the DC electrical storage unit is better capable of performing charging or discharging than outside the range. The optimal state-of-charge range may then differ from one DC electrical storage unit to another.

Alternatively or additionally, the voltage capability may relate to a maximum storage capacity, e.g. in terms of voltage level and/or energy capacity of the DC electrical storage unit, and/or to a state of health of the DC electrical storage unit.

DC electrical storage units of different types may, e.g., originate from different manufacturers and/or have different chemistries.

Each DC/DC power converter has at least one DC electrical storage unit connected thereto. This is done in such a manner that the voltage capability of the DC electrical storage unit(s) matches the DC voltage level rating of the DC/DC power converter. Thereby it is ensured that the DC/DC power converters are able to handle the DC voltage of the DC electrical storage unit(s) connected thereto.

Thus, at least one DC block is formed, and each DC block comprises at least one DC electrical storage unit and at least one DC/DC power converter, connected to each other in the manner described above. Furthermore, each DC block has a voltage capability which is defined by the voltage capability of the DC electrical storage unit(s) of the DC block, and a DC voltage level rating which is defined by the DC voltage level rating(s) of the DC/DC power converter(s) of the DC block. Thus, each DC block may be regarded as a DC electrical storage unit with a specified voltage capability and a specified DC voltage level rating.

Furthermore, each DC block is connected to a DC/AC power converter system via the bus bar and at least one switch. This is done in such a manner that the DC voltage level ratings of the DC/AC power converter systems match the voltage capabilities of the DC blocks. In the present context the term ‘switch’ should be interpreted to mean an electrical contactor. Thereby it is ensured that the DC/AC power converter systems are able to handle the voltage of the DC blocks connected thereto, and vice versa, and thereby that an optimal connection is established between the AC power grid and each of the DC electrical storage units. Accordingly, the capability of each DC electrical storage unit can be utilised in an optimal manner, regardless of the type of the individual DC electrical storage unit. Furthermore, since the connections are provided by means of at least one switch, the system is very flexible in the sense that connections may be established and interrupted, e.g. in the case that one of the DC electrical storage units is replaced.

The DC electrical storage units may be batteries. Batteries are very suitable for use in buffer systems for AC power grids.

At least one of the batteries may be a second life battery. In the present context, the term ‘second life battery’ should be interpreted to mean a battery which has previously been applied for another purpose, but which has been decommissioned from this other purpose, e.g. due to degradation or wear.

For instance, batteries for electrical vehicles are often required to have high performance characteristics, e.g. in terms of charging rate, discharging rate, maximum storage capacity, etc. Such performance characteristics degrade over time, and at a certain point in time, the battery will no longer fulfil the requirements, and is therefore replaced. However, the battery may still be of a sufficiently good quality to allow it to be used for other purposes, for instance for a grid connected battery storage system. Thus, by applying second life batteries in the battery storage system according to the invention, the resource which such a battery represents is utilised more efficiently, in the sense that it is not necessary to discard the battery when it no longer fulfils the strict requirements of electrical vehicles.

Furthermore, since the batteries are connected into the battery storage system in the manner described above, i.e. in such a manner that there is a match between the voltage capability of the batteries, the DC voltage level ratings of the DC/DC power converters and the DC voltage level ratings of the DC/AC power converter systems, and by means of switches, any battery can be connected appropriately into the battery storage system, regardless of the state of the battery, the chemistry of the battery, the original manufacturer of the battery, the charging/discharging capability of the battery, the maximum storage capacity of the battery, etc. Thereby the battery storage system according to the invention is very suitable for accommodating second life batteries.

At least one of the DC/DC power converters may comprise a transformer with a tap changer. For instance, the DC/DC power converter may comprise a combination of a DC/AC converter, a tap changing transformer and an AC/DC converter. According to this embodiment, the DC voltage level can be changed by means of the tap changer, and/or by sending modulating or switching signals to the AC/DC converter, thereby allowing DC electrical storage units to be appropriately connected into the battery storage system. As an alternative, the DC/DC power converters may be in the form of a single power device, in which case the DC voltage level may be changed by sending modulating or switching signals to the DC/DC power converter.

At least one of the DC blocks may comprise two or more DC/DC power converters. Thereby the DC blocks can be appropriately designed to allow a given DC electrical storage unit to be appropriately connected into the battery storage system, e.g. using DC/DC power converters of standard sizes.

The DC/DC power converters may be connected to each other in parallel and/or in series, as long as the resulting DC voltage level ratings match the voltage capability of relevant DC electrical storage unit(s) and the DC voltage level rating of relevant DC/AC power converter systems.

The DC electrical storage units and the DC/DC power converters may be connected to each other by means of one or more switches, in order to form the DC block(s).

According to this embodiment, the forming of the DC blocks is also performed in a flexible and reversible manner, thereby allowing appropriate DC blocks to be easily created, e.g. depending on the characteristics of a given DC electrical storage unit.

At least some of the DC/AC power converter systems may be connected to the AC power grid via a transformer. According to this embodiment, the AC voltage level of the AC power grid can be matched when electrical power is stored in or supplied from the battery storage system. The transformer may advantageously comprise a tap changer.

The transformer may be a poly phase transformer with multiple windings, and the grid connected battery storage system may be connected to one of the windings of the transformer. This allows the voltage supplied to the individual windings of the transformer to be controlled independently of the each other.

For instance, other grid connected battery storage systems may be connected to the other windings of the poly phase transformer. In this case the battery storage systems connected to different windings may be configured differently, e.g. by forming DC blocks in the manner described above.

At least one of the windings of the poly phase transformer may have a dedicated tap changer. This further allows the windings of the transformer to be controlled independently of the each other.

### BRIEF DESCRIPTION OF THE DRAWINGS

The invention will now be described in further detail with reference to the accompanying drawings in which

FIGS. 1-9 illustrate battery storage systems according to various embodiments of the invention, and

FIG. 10 illustrates a voltage control scheme for a battery storage system according to an embodiment of the invention.

### DETAILED DESCRIPTION OF THE DRAWINGS

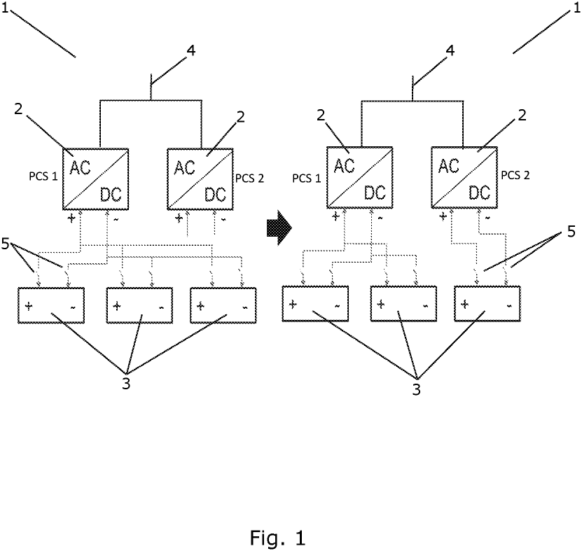

FIG. 1 is a diagrammatic view of a grid connected battery storage system 1 according to a first embodiment of the invention in two different configurations. The battery storage system 1 comprises two DC/AC power converter systems 2 and three DC blocks 3, each DC block 3 comprising at least one DC electrical storage unit (not shown) and at least one DC/DC power converter (not shown). The DC electrical storage units and the DC/DC power converters are connected to each other to form the DC blocks 3 in such a manner that voltage capabilities of the DC electrical storage units and DC voltage level ratings of the DC/DC power converters match. Furthermore, each DC block 3 has a voltage capability which is defined by the DC electrical storage unit(s) which form part of the DC block 3, and a DC voltage level rating which is defined by the DC/DC power converter(s) which form part of the DC block 3.

The AC sides of the DC/AC power converter systems 2 are connected to an AC power grid via connection 4.

Each DC block 3 is selectably connectable to the DC side of one or both of the DC/AC power converter systems 2. In the left side of FIG. 1, all three DC blocks 3 are connected in parallel to the left-most DC/AC power converter system 2 (PCS1). In the right side of FIG. 1, two of the DC blocks 3 are connected in parallel to the left-most DC/AC power converter system 2 (PCS1), and one of the DC blocks 3 is connected to the right-most DC/AC power converter system 2 (PCS2).

The DC/AC power converter systems 2 as well as the DC blocks 3 have different specifications and/or characteristics, e.g. in terms of voltage capability and DC voltage level ratings. When selecting a configuration, i.e. how to interconnect the DC/AC power converter systems 2 and the DC blocks 3 as illustrated by the two examples of the right side and the left side of FIG. 1, respectively, the characteristics of the DC/AC power converter systems 2 as well as the characteristics of the DC blocks 3 are taken into account, in order to ensure that the best possible match between DC/AC power converter systems 2 and DC blocks 3 is obtained.

The connections between the DC blocks 3 and the DC/AC power converter systems 2 are established by means of switches (not shown), and thereby the configuration of the battery storage system 1 can be changed, e.g. from the configuration of the right side of FIG. 1 to the configuration of the left side of FIG. 1, or vice versa, by appropriately operating the switches. Accordingly, when a DC block 3, or a DC electrical storage unit, is connected into the battery storage system 1, an appropriate configuration may be selected, and the switches may be arranged in appropriate positions to establish the configuration.

During operation, the individual DC blocks 3 can be connected to the AC power grid, via the relevant DC/AC power converter system 2, in order to store electrical energy in the DC electrical storage units of the DC blocks 3, or in order to provide stored electrical energy from the DC electrical storage units of the DC blocks 3 to the AC power grid, depending on what the AC power grid requires. This is done by appropriately operating switches 5.

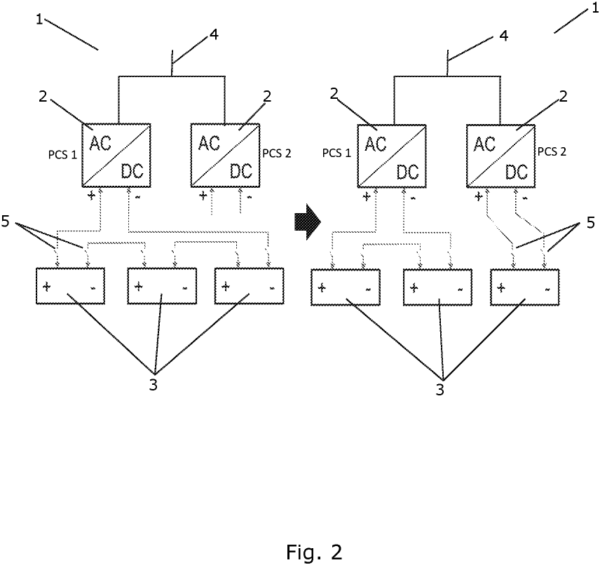

FIG. 2 is a diagrammatic view of a grid connected battery storage system 1 according to a second embodiment of the invention. The battery storage system 1 of FIG. 2 is very similar to the battery storage system 1 of FIG. 1, and it will therefore not be described in detail here.

However, in the battery storage system 1 of FIG. 2, the DC blocks 3 are connected in series to the DC/AC power converter systems 2.

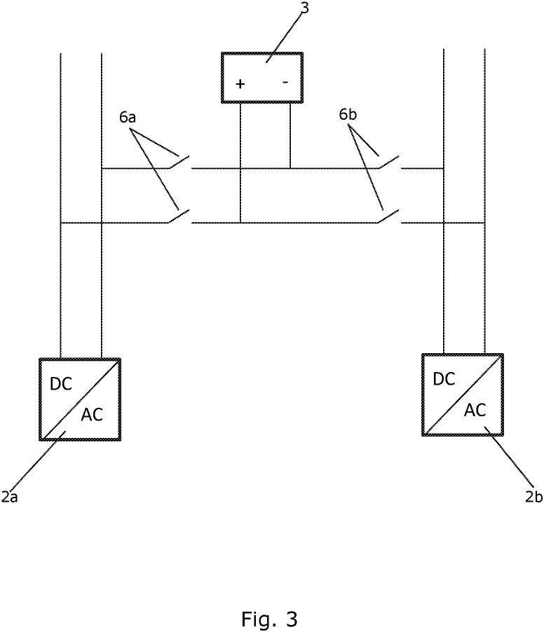

FIG. 3 is a diagrammatic view of a grid connected battery storage system 1 according to a third embodiment of the invention. The battery storage system 1 comprises a number of DC/AC power converter systems 2 and a number of DC blocks 3. Similarly to the DC blocks 3 illustrated in FIG. 1, the DC blocks 3 comprise at least one DC electrical storage unit and at least one DC/DC power converter. For the sake of simplicity, two DC/AC power converter systems 2 and one DC block 3 are shown in FIG. 3. It should, however, be noted that the battery storage system 1 could comprise further DC/AC power converter systems 2 and/or further DC blocks 3.

The DC block 3 is selectably connectable to each of the two DC/AC power converter systems 2a, 2b, via switches 6a, 6b. In FIG. 3 all of the switches 6a, 6b are open, and the DC block 3 is therefore not connected to any of the DC/AC power converter systems 2. However, by closing the switches 6a, the DC block 3 is connected to DC/AC power converter system 2a, and by closing the switches 6b, the DC block 3 is connected to DC/AC power converter system 2b.

When a DC blocks 3 is to be connected to the battery storage system 1, characteristics of the DC block 3, at least in terms of voltage capability and DC voltage level rating, are determined, and a DC/AC power converter system 2 which matches the characteristics, at least in terms of voltage capability, is selected. The DC block 3 can then be connected to the AC power grid via the selected DC/AC power converter system 2. Thereby it is ensured that the DC block 3 receives and delivers electrical energy from and to the AC power grid in a manner which is as optimal as possible.

It should be noted that the decision regarding which DC/AC power converter system 2 the DC block 3 is to be connected to may, alternatively or additionally, be made during operation of the battery system 1, and in accordance with requirements of the AC power grid.

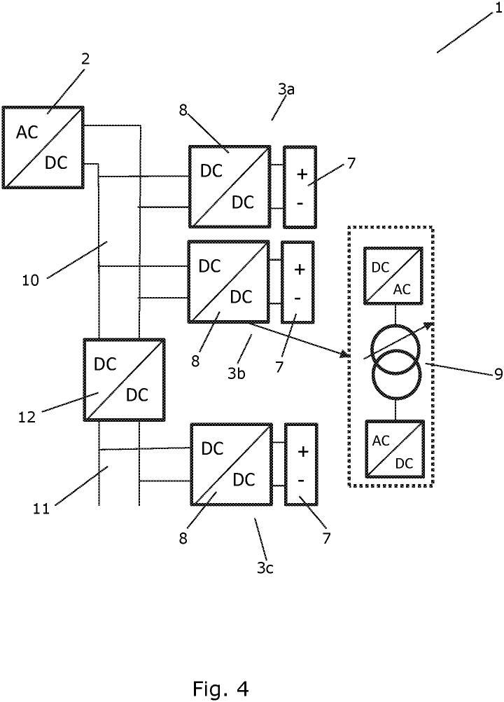

FIG. 4 is a grid connected battery storage system 1 according to a fourth embodiment of the invention. The battery storage system 1 comprises a number of DC/AC power converter systems 2, one of which is shown, and a number of DC blocks 3, three of which are shown.

Each DC block 3 comprises a number of DC electrical storage units 7 and a number of DC/DC power converters 8. For the sake of simplicity, FIG. 4 illustrates only one DC electrical storage unit 7 and one DC/DC power converter 8 for each DC block 3. It should, however, be noted that one or more of the DC blocks 3 could comprise two or more DC electrical storage units 7 and/or two or more DC/DC power converters 8. Furthermore, the number of DC electrical storage units 7, as well as the number of DC/DC power converters 8, may differ from one DC block 3 to another.

Each of the DC electrical storage units 7 defines a voltage capability, such as a voltage range, relating to charging and/or discharging of the DC electrical storage unit 7. The voltage capabilities of the DC electrical storage units 7 differ, i.e. the voltage capabilities may differ from one DC electrical storage unit 7 to another. Accordingly, the DC electrical storage units 7 are of at least two different types. The DC electrical storage units 7 may, e.g., be in the form of batteries.

Each DC/DC power converter 8 defines a DC voltage level rating. The DC voltage level ratings of the DC/DC power converters 8 differ from one DC/DC power converter 8 to another.

Each DC block 3 has been configured by connecting at least one DC electrical storage unit 7 to at least one DC/DC power converter 8. The DC blocks 3 are configured in such a manner that the voltage capabilities of the DC electrical storage units 7 match the DC voltage level ratings of the DC/DC power converters 8. Thereby it is ensured that the voltage capabilities of the DC electrical storage units 7 as well as the DC voltage level ratings of the DC/DC power converters 8 can be utilised optimally during charging and discharging of the DC electrical storage units 7. Furthermore, each DC block 3 has a voltage capability which is defined by the voltage capability of the DC electrical storage unit 7 thereof, and a DC voltage level rating which is defined by the DC voltage level rating of the DC/DC power converter 8 thereof.

The DC/DC power converter 8 of DC block 3b comprises a tap changer 9. This allows the DC voltage levels to and from the DC/DC power converter 8 to be adjusted to better match the DC electrical storage unit 7 and/or the DC/AC power converter system 2.

DC blocks 3a and 3b are connected to the DC/AC power converter system 2 via a first DC bus bar 10. DC block 3c is connected to a second DC bus bar 11, which is connected to the first DC bus bar 10 via a DC/DC power converter 12. Accordingly, DC block 3c is connected to the DC/AC power converter system 2 via the DC/DC power converter 12. The DC voltage supplied between the DC/AC power converter system 2 and the DC block 3c can thereby be adjusted in order to provide a better match.

Thus, the DC blocks 3 are connected to the DC/AC power converter system 2 in an appropriate and matching manner, thereby allowing DC electrical storage units 7 of various types to be accommodated in the battery storage system 1 in an optimal manner, and in a manner which targets the voltage capabilities of the DC electrical storage units 7.

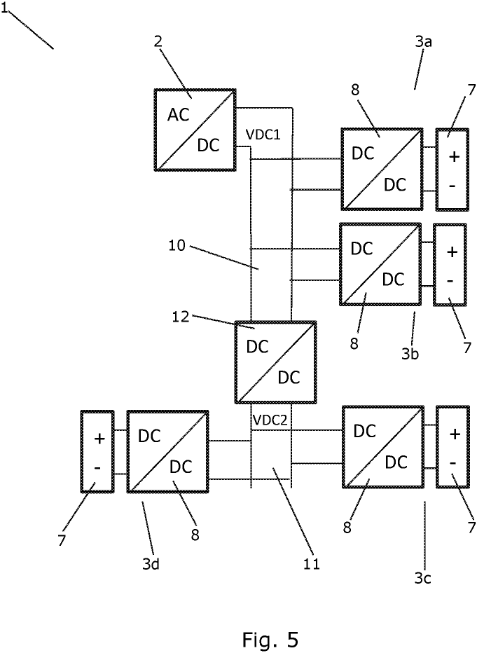

FIG. 5 is a diagrammatic view of a grid connected battery storage system 1 according to a fifth embodiment of the invention. The battery storage system 1 of FIG. 5 is very similar to the battery storage system 1 of FIG. 4, and it will therefore not be described in detail here.

In the battery storage system 1 of FIG. 5, an additional DC block 3d is shown. The DC block 3d is connected to the DC/AC power converter system 2 via the DC/DC power converter 12 in the same manner as DC block 3c.

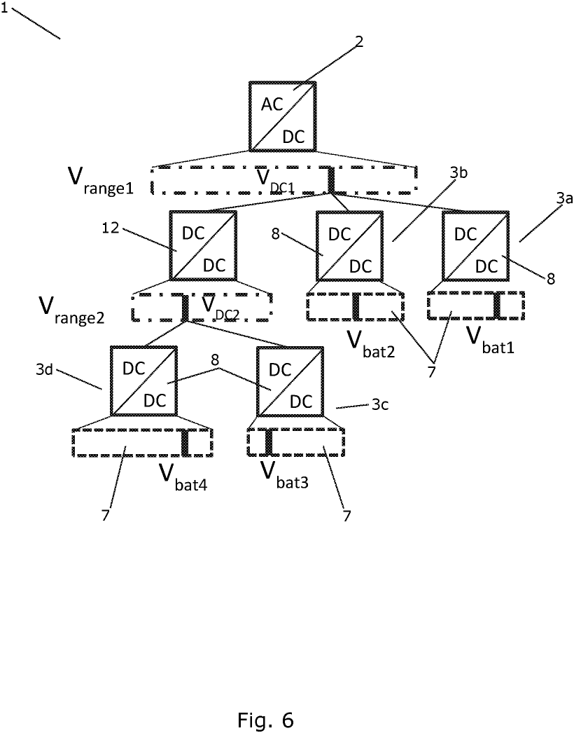

FIG. 6 illustrates the grid connected battery storage system 1 of FIG. 5. For each of the DC blocks 3, a voltage storage range for the respective DC electrical storage units 7 is illustrated by vertical lines. For instance, it can be seen that the voltage storage range for DC block 3a is larger than the voltage storage range for DC block 3b, and that the voltage storage range for DC block 3d is larger than the voltage storage range for DC block 3c.

Furthermore, converter voltage ranges for the DC/AC power converter system 2 and for the DC/DC power converter 12 are illustrated by similar vertical lines.

The battery storage system 1 is configured in such a way that the voltage ranges of the DC blocks 3 and the converters 2, 12 match, in particular in such a manner that each DC electrical storage unit 7 is connected appropriately to the DC/AC power converter system 2, e.g. in order to fully utilise the various storage capacities of the DC electrical storage units 7. For instance, further DC/DC power converters 12 may be included into the battery storage system 1, in order to target even more types of DC electrical storage units 7.

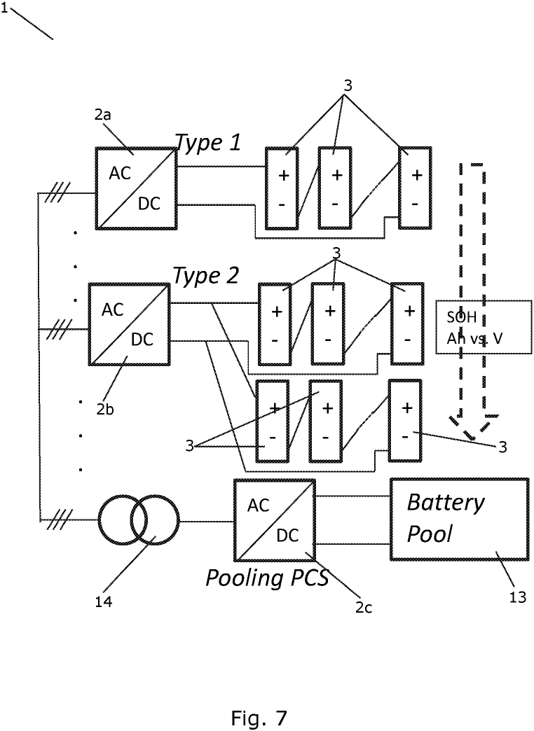

FIG. 7 is a diagrammatic view of a grid connected battery storage system 1 according to a sixth embodiment of the invention. The battery storage system 1 comprises three DC/AC power converter systems 2 and nine DC blocks 3, each comprising at least one DC electrical storage unit (not shown) and at least one DC/DC power converter (not shown). Further DC electrical storage units are arranged in a battery pool 13 which is connected to one of the DC/AC power converter systems 2c.

The DC/AC power converter systems 2 as well as the DC electrical storage units of the DC blocks 3 are of different types. More particularly, the DC electrical storage units of the DC blocks 3 differ from each other with regard to state of health. The DC blocks 3 are grouped in such a manner that the ones with the best state of health are connected to the uppermost DC/AC power converter system 2a, and the middle DC/AC power converter system 2b has DC blocks 3 with a lower state of health connected thereto. Finally, the DC electrical storage units with the poorest state of health are arranged in the battery pool 13, and thereby connected to the lowermost DC/AC power converter system 2c.

Thus, the DC electrical storage units of the poorest state of health are pooled together and connected to the AC power grid via DC/AC power converter system 2c.

The lowermost DC/AC power converter system 2c is connected to the AC power grid via a transformer. Thereby the AC output of this DC/AC power converter system 2 is brought to the same voltage level as the AC outputs of the other DC/AC power converter systems 2a, 2b. Thereby the DC electrical storage unit of the poorest state of health can still be applied for providing grid services to the AC power grid.

The state of health of the DC electrical storage units of the various DC blocks 3 may be monitored over time, and the DC electrical storage units may be relocated in the battery storage system 1 in the case that their state of health drops below a certain level.

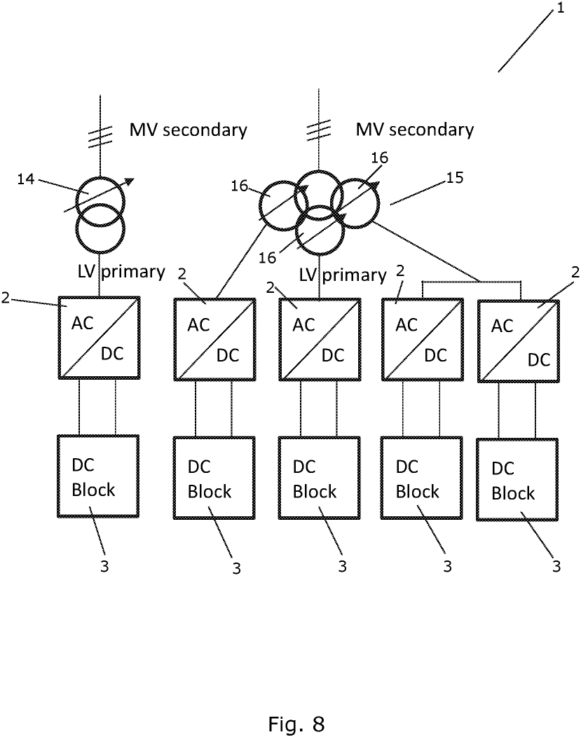

FIG. 8 is a diagrammatic view of a grid connected battery storage system 1 according to a seventh embodiment of the invention. The battery storage system 1 comprises five DC/AC power converter systems 2 and five DC blocks 3, each DC block 3 being connected to a DC/AC power converter system 2.

The DC/AC power converter systems 2 all have their AC side connected to an AC power grid via a transformer 14, 15. One of the transformers is a two winding transformer 14, and only one of the DC/AC power converter systems 2 is connected thereto.

The other transformer is a multiple winding transformer 15 with three windings 16. Two of the windings 16 each has a single DC/AC power converter system 2 connected thereto, and the third winding 16 has two DC/AC power converter systems 2 connected in parallel thereto. By connecting separate DC/AC power converter systems 2 to separate windings 16 of the multiple winding transformer 15, the voltage supplied to or received from the windings 16 of the multiple winding transformer 15 can be controlled independently of each other.

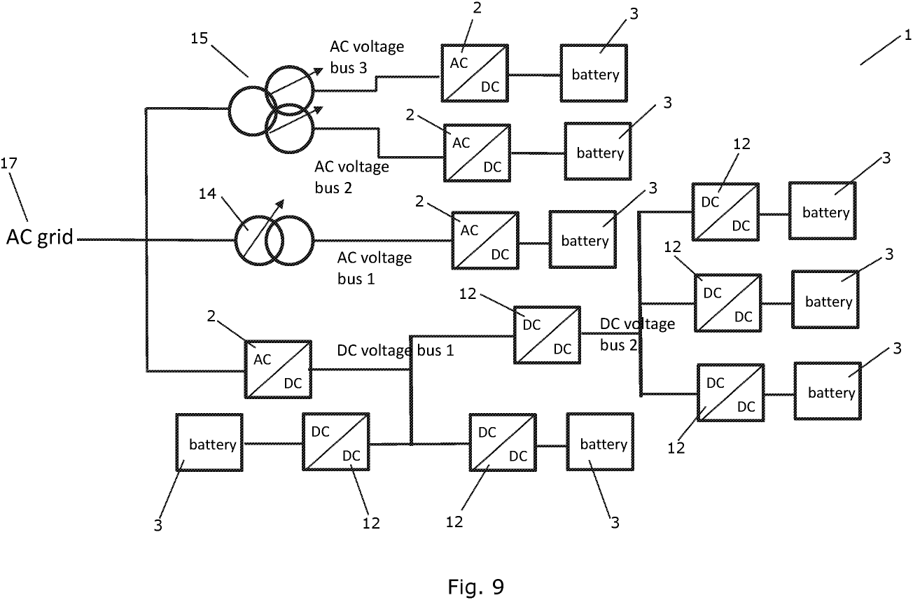

FIG. 9 is a diagrammatic view of a grid connected battery storage system 1 according to an eighth embodiment of the invention. The battery storage system 1 comprises several DC/AC power converter systems 2, DC blocks 3 and DC/DC power converters 12, and the battery storage system 1 is connected to an AC power grid 17. The various elements of the battery storage system 1 have been described above with reference to FIGS. 1-8, and they will therefore not be described in detail here. FIG. 9 illustrates that the battery storage system 1 may be complex and comprise a vast number of elements which can be interconnected in a flexible manner.

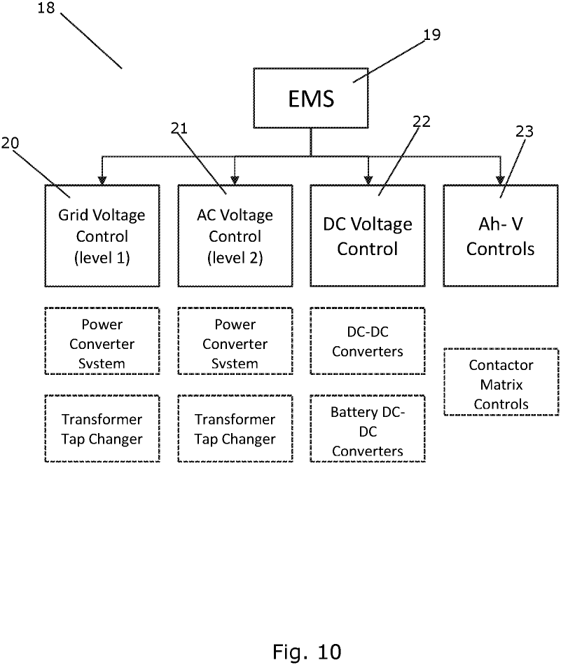

FIG. 10 illustrates a control scheme 18 for a battery storage system according to an embodiment of the invention. The battery storage system being controlled by the means of the control scheme 18 of FIG. 10 may, e.g., be any of the battery storage systems of FIGS. 1-9.

Energy management system (EMS) 19 is responsible for the overall control of the battery storage system. Grid voltage control 20 controls the output voltage of grid-facing/grid-connected power converters and transformers, e.g. by means of switching signal and tap changer, respectively. AC voltage control 21 controls the input voltage to the grid transformer or output voltage of the power converter connected to the grid transformer, e.g. by means of tap changer and switching signals, respectively. DC voltage control 22 controls the DC bus voltage and output voltage of all the DC/DC converters connected to the DC electrical storage units. Ah-V controls 23 controls the various switching devices that allow the DC electrical storage units to be reconfigured in such a way that multiple DC electrical storage units can be connected in series or in parallel behind an appropriate DC/DC or AC/DC converter. This is done in such a way that grouping of DC electrical storage units with comparable DC voltage range and/or state-of-health and/or other technical characteristics is obtained.

1. A grid connected battery storage system comprising:
two or more DC/AC power converter systems, each DC/AC power converter system being connected to an AC power grid and to a DC bus bar, and the DC/AC power converter systems being of at least two different DC voltage level ratings;
two or more DC/DC power converters, the DC/DC power converters being of at least two different DC voltage level ratings; and
two or more DC electrical storage units, the DC electrical storage units being of at least two types, where different types of DC electrical storage units have different voltage capabilities relating to charging and/or discharging of the DC electrical storage unit,
wherein each DC/DC power converter has at least one DC electrical storage unit connected thereto, in such a manner that the voltage capability of the DC electrical storage unit(s) matches the DC voltage level rating of the DC/DC power converter, thereby forming at least one DC block, each DC block comprising at least one of the at least two DC electrical storage unit and at least one of the at least two DC/DC power converter, each DC block having a voltage capability defined by the voltage capability of the DC electrical storage unit(s) of the DC block and a DC voltage level rating defined by the DC voltage level rating(s) of the DC/DC power converter(s), and wherein each DC block is connected to a DC/AC power converter system via the DC bus bar and at least one switch, in such a manner that the DC voltage level ratings of the DC/AC power converter systems match the voltage capability of the DC blocks.

2. A grid connected battery storage system according to claim 1, wherein the DC electrical storage units are batteries.

3. A grid connected battery storage system according to claim 2, wherein at least one of the batteries is a second life battery.

4. A grid connected battery storage system according to claim 1, wherein at least one of the DC/DC power converters comprises a transformer with a tap changer.

5. A grid connected battery storage system according to claim 1, wherein at least one of the DC blocks comprises two or more DC/DC power converters.

6. A grid connected battery storage system according to claim 1, wherein the DC electrical storage units and the DC/DC power converters are connected to each other by means of one or more switches, in order to form the DC block(s).

7. A grid connected battery storage system according to claim 1, wherein at least some of the DC/AC power converter systems (2) are connected to the AC power grid via a transformer.

8. A grid connected battery storage system according to claim 7, wherein the transformer is a poly phase transformer with multiple windings, and wherein the grid connected battery storage system is connected to one of the windings of the transformer.

9. A grid connected battery storage system according to claim 8, wherein other grid connected battery storage systems are connected to the other windings of the poly phase transformer.

10. A grid connected battery storage system according to claim 8, wherein at least one of the windings of the poly phase transformer has a dedicated tap changer.
